(19) United States
(12) Patent Application Publication
(10) Pub. No.: US 2008/0254837 A1
(43) Pub. Date: Oct. 16, 2008

(54) ADJUSTMENT OF SCREEN TEXT SIZE

(75) Inventors: Gunnar Klinghult, Lund (SE); Maria Lindback, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATION AB, Lund (SE)

(21) Appl. No.: 11/733,627

(22) Filed: Apr. 10, 2007

(51) Int. Cl. H04M 1/00

(52) U.S. Cl. 455/566

(57) ABSTRACT

A motion sensor monitors the motion of a mobile phone. If it is determined that the mobile phone is shaking, the text on the display of the mobile phone may be increased. If it is determined that the mobile phone is not shaking, the text on the display of the mobile phone may be decreased.

### BACKGROUND

Mobile phones can be relatively small and easily carried. Because of the portability, as well as the convenience, of mobile phones, many users take their mobile phones with them wherever they go. When a user is engaged in an activity such as jogging or bike riding, it may be difficult to read the display of the mobile phone due to the “bumpiness” of the activity. Additionally, some users may have very unsteady or shaky hands. In this situation, also, it may be difficult to read the display.

### SUMMARY

According to one aspect, a method includes monitoring signals of a motion sensor of a mobile phone, determining, based on the monitoring, whether the mobile phone is shaking, and increasing a size of objects on a display of the mobile phone when it is determined that the mobile phone is shaking.

Additionally, the objects on the display include one of text, icons, graphics, or components displayed on the display

Additionally, the motion sensor includes one of an accelerometer, a gyroscope, or a magnetic field sensor.

Additionally, the method includes further increasing the size of the objects when the shaking increases.

Additionally, increasing the size of the objects includes increasing the size of the objects after a first period of time.

Additionally, the method includes decreasing the size of the objects when the shaking subsides.

Additionally, decreasing the size of the objects includes decreasing the size of the objects after a second period of time.

According to another aspect, a mobile phone includes a memory, a display, a motion sensor, and processing logic configured to: monitor a motion signal of the motion sensor, determine, based on the monitoring, whether the mobile phone is shaking, and increase a size of objects on the display when the mobile phone is shaking.

Additionally, the objects on the display include one of text, icons, graphics, or components displayed on the display

Additionally, the motion sensor includes one of an accelerometer, a gyroscope, or a magnetic field sensor.

Additionally, the processing logic is further configured to monitor motion signals of the motion sensor corresponding to a plurality of axes.

Additionally, the processing logic is further configured to further increase the size of the objects when the shaking of the mobile phone increases.

Additionally, the processing logic is further configured to increase the size of the objects when the mobile phone is determined to be shaking over a first period of time.

Additionally, the processing logic is further configured to decrease the size of the objects when the shaking of the mobile phone subsides.

Additionally, the processing logic is further configured to decrease the size of the objects after a second period of time.

According to yet another aspect, a method includes monitoring vibration of a mobile phone, and increasing a size of objects on a display of the mobile phone based on the vibration.

Additionally, the objects on the display include one of text, icons, graphics, or components displayed on the display

Additionally, monitoring vibration includes monitoring vibration with one of an accelerometer, a gyroscope, or a magnetic field sensor.

Additionally, the method includes further increasing the size of the objects based on an increase in vibration.

Additionally, increasing the size of the objects includes increasing the size of the objects after a first period of time.

Additionally, the method includes decreasing the size of the objects based on a decrease in vibration.

Additionally, decreasing the size of the objects includes decreasing the size of the objects after a second period of time.

Additionally, monitoring vibration includes monitoring motion signals of a motion sensor corresponding to a plurality of axes.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram of an exemplary device in which systems and methods described herein may be implemented;

FIG. 2 is a diagram of exemplary components of the exemplary device of FIG. 1; and

FIGS. 3 and 4 are flowcharts of exemplary processes according to implementations described herein.

FIGS. 5A-5C are examples of the exemplary processes of FIGS. 3 and 4.

### DETAILED DESCRIPTION

The following detailed description refers to the accompanying drawings. The same reference numbers in different drawings may identify the same or similar elements. Also, the following detailed description does not limit the invention.

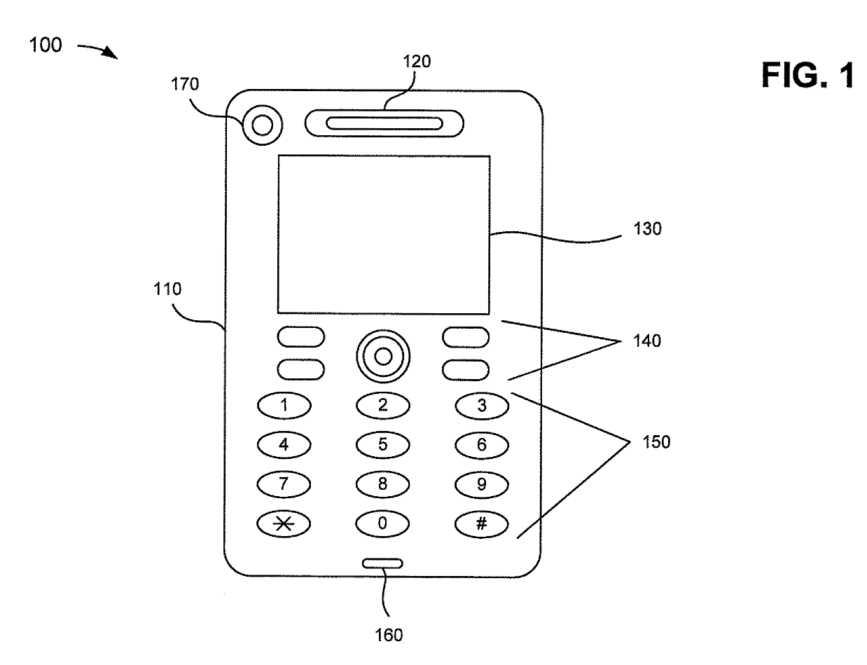

FIG. 1 is a diagram of an exemplary mobile phone 100 according to an implementation described herein. As shown in FIG. 1, mobile phone 100 may include a housing 110, a speaker 120, a display 130, control buttons 140, a keypad 150, a microphone 160, and a camera 170. Housing 110 may protect the components of mobile phone 100 from outside elements. Speaker 120 may provide audible information to a user of mobile phone 100 or to microphone 160. Display 130 may provide visual information to the user. For example, display 130 may provide information regarding reminders, incoming or outgoing calls, media, games, phone books, the current time, etc. Control buttons 140 may permit the user to interact with mobile phone 100 to cause mobile phone 100 to perform one or more operations. Keypad 150 may include a standard telephone keypad and/or a standard QWERTY keyboard. Microphone 160 may receive audible information from the user. Camera 170 may enable a user to capture and store video and/or images (e.g., pictures).

Although FIG. 1 shows exemplary components of mobile phone 100, in other implementations, mobile phone 100 may include additional, different, or fewer components than depicted in FIG. 1. For example, mobile phone 100 may include a touch screen (e.g., display 130 may be a touch screen) tat may permit the user to interact with mobile phone 100 to cause mobile phone 100 to perform one or more operations. The touch screen may be manipulated by touching or contacting the display with a pen or a finger.

Mobile phone 100 may include a motion sensor such as, for example, an accelerometer, to detect the movement of mobile phone 100. The use of a motion sensor with mobile phone 100 will be particularly described in more detail below. One or more components of mobile phone 100 may perform the functions of one or more other components of mobile phone 100.

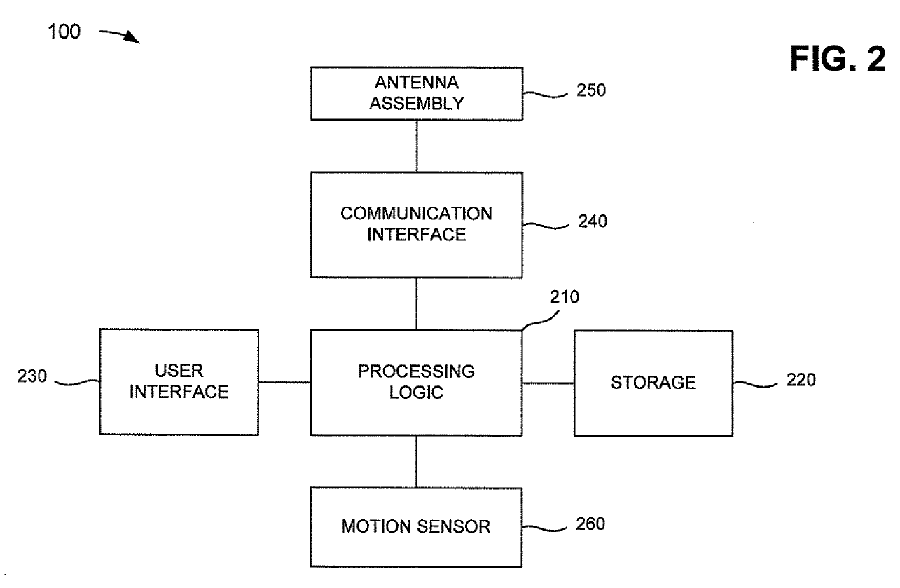

FIG. 2 is a diagram of exemplary functional components of mobile phone 100. As shown in FIG. 2, mobile phone 100 may include processing logic 210, storage 220, a user interface 230, a communication interface 240, an antenna assembly 250, motion detection logic 260, and motion sensor 270. Motion detection logic 260 may include circuitry associated with motion sensor 270. Processing logic 210 may include a processor, microprocessor, an application specific integrated circuit (ASIC), field programmable gate array (FPGA), or the like. Storage 220 may include a random access memory (RAM), a read only memory (ROM), and/or another type of memory to store data and instructions that may be used by processing logic 210 to control operation of mobile phone 100 and its components.

User interface 230 may include mechanisms for inputting information to mobile phone 100 and/or for outputting information from mobile phone 100. Examples of input and output mechanisms might include a speaker (e.g., speaker 120) to receive electrical signals and output audio signals, a camera (e.g., camera 170) to receive image and/or video signals and output electrical signals, buttons (e.g., a joystick, control buttons 140 and/or keys of keypad 150) to permit data and control commands to be input into mobile phone 100, a display (e.g., display 130) to output visual information (e.g., information from camera 170), and/or a vibrator to cause mobile phone 100 to vibrate.

Communication interface 240 may include, for example, a transmitter that may convert baseband signals from processing logic 210 to radio frequency (RF) signals and/or a receiver that may convert RF signals to baseband signals. Alternatively, communication interface 240 may include a transceiver to perform functions of both a transmitter and a receiver. Communication interface 240 may connect to antenna assembly 250 for transmission and reception of the RF signals. Antenna assembly 250 may include one or more antennas to transmit and receive RF signals over the air. Antenna assembly 250 may receive RF signals from communication interface 240 and transmit them over the air and receive RF signals over the air and provide them to communication interface 240.

Motion sensor 260 may measure acceleration or vibration of mobile phone 100. In one implementation, motion sensor 260 may include one or more accelerometers. Motion sensor 260 may sense acceleration in up to three axes. Motion sensor 260 may provide a signal indicating acceleration for each axis being monitored to processing logic 210.

As will be described in more detail below, processing logic 210 may determine, based on signals from motion sensor 260, whether mobile phone 100 is moving or vibrating in a “bumpy” or “shaky” pattern. In response, processing logic 210 may increase the size of objects on display 130 to make it easier for a user to read. Objects on display 130 may include text, icons, graphics, or components of the user interface displayed on display 130.

### Exemplary Processes

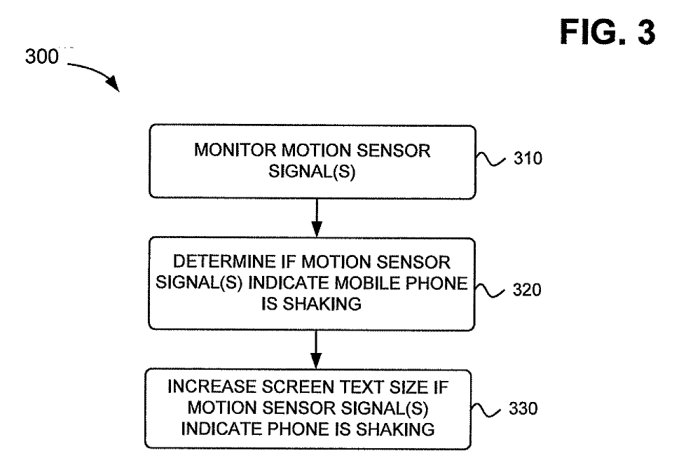

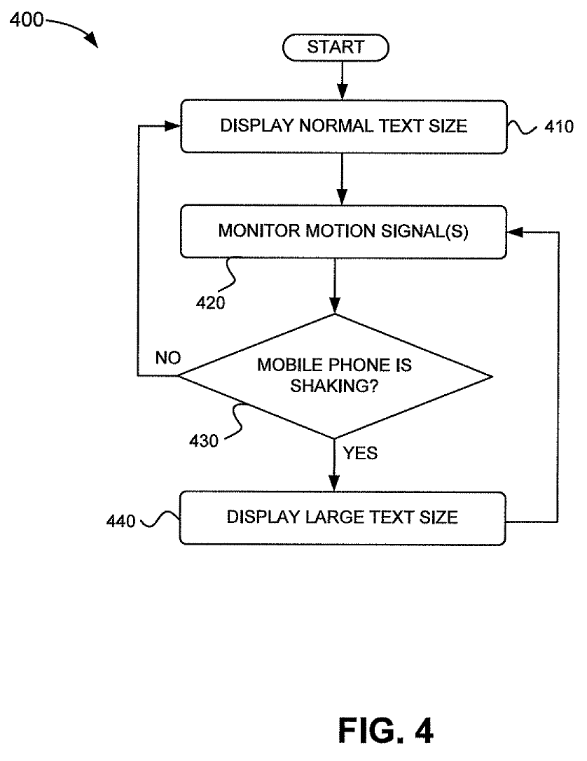

FIGS. 3 and 4 are flowcharts of exemplary processes according to implementations described herein. The process of FIG. 3, in general, detects when a mobile phone is vibrating or shaking and increases the text size to make the text easier to read. Consistent with this, the process of FIG. 4 generally illustrates adjusting the size of the text on display 130 depending upon an amount of vibration of mobile phone 100.

As shown in FIG. 3, process 300 may begin with monitoring the signal(s) from motion sensor 260 (block 310). Motion sensor 260 may detect acceleration or vibration of mobile phone 100 in up to three axes. For example, motion sensor 260 may detect motion when a user is running or riding a bike, when a user is sitting in a boat that is rocking side to side and up and down, or when a user is experiencing shaky hands.

As further shown in FIG. 3, process 300 may continue by determining whether the motion sensor signal(s) indicate that mobile phone 100 is vibrating or shaking above a threshold level (block 320). Different patterns of motion and levels of acceleration may determine the degree of vibration. For example, if a user is walking or sitting in an anchored boat, motion sensor 260 may sense slight amounts of vibration. If, however, the user is running or sitting in a moving boat, motion sensor 260 may sense a much greater degree of vibration.

When it is determined that mobile phone 100 is shaking or vibrating at more than an acceptable or normal amount, the text size on display 130 may be increased to be more easily read (block 330). In one embodiment, if the degree of shakiness is determined to be moderate (such as when the user a user is walking or sitting in an anchored boat), the text size may be increased by a first amount. In another embodiment, if the degree of shakiness is determined to be greater (such as when the user is running or sitting in a moving boat), the text may be enlarged by a greater amount. There may be any number of text sizes corresponding to different amounts of vibration. If the degree of vibration or shakiness is determined to be “normal” or insignificant, no action may be taken.

A more in-depth explanation of the process of FIG. 3 is shown in FIG. 4. As shown in FIG. 4, process 400 may begin when normal-sized text is displayed on display 130 (block 410). The text on display 130 may display, for example, the time, the date, the name of an incoming caller, a text message, or a name of a song that is playing.

As further shown in FIG. 4, process 400 may continue with the monitoring of the motion signal(s) of motion sensor 260 (block 420). As described above, motion sensor 260 may determine a degree of acceleration or vibration. Motion may be detected when, for example, a user is playing sports, biking, jogging or running, walking, and using a treadmill, elliptical machine, or stationary bike. Furthermore, motion may be detected, for example, when a user is in a moving car or on a boat. Motion may also be detected simply if a user has shaky hands.

In block 430, it may be determined whether the degree of acceleration or vibration is above an acceptable level. If so, the mobile phone maybe determined to be “shaking.” In one embodiment, different degrees of user activity may correspond to different degrees of shakiness. For example, if a user is walking, mobile phone may be slightly shaking. However, if the user begins jogging, the shaking of mobile phone 100 may increase. There may be any number of levels of shakiness corresponding to different degrees of user activity.

If it is determined that mobile phone 100 is not shaking (block 430—NO), the text size on display 130 may remain the same. If it is determined that mobile phone 100 is shaking (block 430—YES), a larger text size may be displayed on display 130 (block 440). The larger text size may help a user read the text. For example, if a user wants to change a song while jogging, a larger text size may enable the user to see which song is playing. Different text sizes may correspond to different degrees of shakiness. For example, if a user is walking and the shakiness of mobile phone 100 is relatively low, a medium-sized text may be displayed on display 130. If, however, the user begins jogging and the shakiness of mobile phone 100 increases, a large-sized text may be displayed on display 130. There may be any number of different text sizes to correspond to any amount of shakiness of mobile phone 100.

In one embodiment, a larger text size may be displayed on mobile phone 100 only when the shaking continues for a first period of time. For example, assume a user is sitting at a desk with mobile phone 100 in his or her pocket and mobile phone 100 is not moving. The user may stand, momentarily shaking mobile phone 100. If the user begins to walk and mobile phone 100 continues shaking, after a delay (e.g. 3-5 seconds), the text size may increase. If, however, the user continues to stand or sits back down, mobile phone 100 may stop moving before the end of the delay, and the text size may not increase.

When the larger text size is displayed, the signal(s) of motion sensor 260 may continue to be monitored (block 420) and a determination may be made whether mobile phone 100 is shaking (block 430). If mobile phone 100 continues to shake (block 430—YES), the larger text size may continue to be displayed on display 130. If, however, mobile phone 100 stops shaking (block 430—NO), the normal text size may be displayed (block 410). In one embodiment, there may be a delay (e.g. 3-5 seconds) between when mobile phone 100 stops shaking and when the text size decreases.

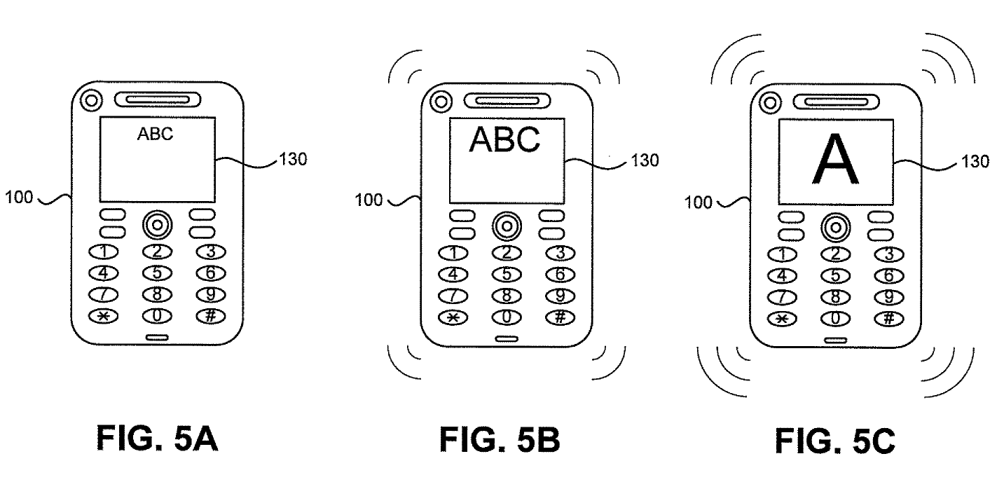

FIGS. 5A-5C illustrate examples of the exemplary processes of FIGS. 3 and 4. For FIG. 5A, assume the amount of shakiness of mobile phone 100 is very low. Accordingly, as shown in FIG. 5A, the text size may be small. For example, mobile phone 100 may be on a table or may be in the pocket of a user who is sitting or standing relatively still. Assume, however, that the amount of shakiness of mobile 100 may increase slightly. For example, a user may receive a text message while sitting in a rocking boat or while walking. In this case, as shown in FIG. 5B, the text displayed on display 130 may be larger to make it easier for the user to read. As another example, assume the amount of shakiness of mobile phone 100 is even greater. For example, a user may receive a text message while in a moving boat (with increased rocking) or while running. In this case, as shown in FIG. 5C, the text displayed on display 130 may be much larger in order to be read by the user.

### CONCLUSION

Implementations described herein relate to the size of objects on a display of a mobile phone. In one implementation, the size of objects on the display may be increased when it is determined that the mobile phone is shaking. The size of objects on the display may be decreased when the mobile phone stops shaking.

The foregoing description provides illustration and description, but is not intended to be exhaustive or to limit the invention to the precise form disclosed. Modifications and variations are possible in light of the above teachings or may be acquired from practice of the invention.

For example, while series of acts have been described with regard to FIGS. 3 and 4, the order of the acts may be modified in other implementations. Further, non-dependent acts may be performed in parallel.

It should be emphasized that the term “comprises/comprising” when used in the this specification is taken to specify the presence of stated features, integers, steps or components but does not preclude the presence or addition of one or more other features, integers, steps, components or groups thereof.

It will be apparent that aspects, as described above, may be implemented in many different forms of software, firmware, and hardware. The actual software code or specialized control hardware used to implement aspects described herein is not limiting of the invention. Thus, the operation and behavior of the aspects were described without reference to the specific software code—it being understood that one would be able to design software and control hardware to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
monitoring signals of a motion sensor of a mobile phone;
determining, based on the monitoring, whether the mobile phone is shaking; and
increasing a size of objects on a display of the mobile phone when it is determined that the mobile phone is shaking.

2. The method of claim 1, wherein the objects on the display include one of text, icons, graphics, or components displayed on the display.

3. The method of claim 1, wherein the motion sensor includes one of an accelerometer, a gyroscope, or a magnetic field sensor.

4. The method of claim 1, further comprising further increasing the size of the objects when the shaking increases.

5. The method of claim 1, wherein increasing the size of the objects includes increasing the size of the objects after a first period of time.

6. The method of claim 1, further comprising:
decreasing the size of the objects when the shaking subsides.

7. The method of claim 6, wherein decreasing the size of the objects includes decreasing the size of the objects after a second period of time.

8. A mobile phone comprising:
a memory;
a display;
a motion sensor; and
processing logic configured to:
monitor a motion signal of the motion sensor;
determine, based on the monitoring, whether the mobile phone is shaking; and
increase a size of objects on the display when the mobile phone is shaking.

9. The mobile phone of claim 8, wherein the objects on the display include one of text, icons, graphics, or components displayed on the display.

10. The mobile phone of claim 8, wherein the motion sensor includes one of an accelerometer, a gyroscope, or a magnetic field sensor.

11. The mobile phone of claim 8, wherein the processing logic is further configured to monitor motion signals of the motion sensor corresponding to a plurality of axes.

12. The mobile phone of claim 8, wherein the processing logic is further configured to further increase the size of the objects when the shaking of the mobile phone increases.

13. The mobile phone of claim 8, wherein the processing logic is further configured to increase the size of the objects when the mobile phone is determined to be shaking over a first period of time.

14. The mobile phone of claim 8, wherein the processing logic is further configured to decrease the size of the objects when the shaking of the mobile phone subsides.

15. The mobile phone of claim 14, wherein the processing logic is further configured to decrease the size of the objects after a second period of time.

16. A method comprising:
monitoring vibration of a mobile phone; and
increasing a size of objects on a display of the mobile phone based on the vibration.

17. The method of claim 16, wherein the objects on the display include one of text, icons, graphics, or components displayed on the display.

18. The method of claim 16, wherein monitoring vibration includes monitoring vibration with one of an accelerometer, a gyroscope, or a magnetic field sensor.

19. The method of claim 16, further comprising further increasing the size of the objects based on an increase in vibration.

20. The method of claim 16, wherein increasing the size of the objects includes increasing the size of the text after a first period of time.

21. The method of claim 16, further comprising decreasing the size of the objects based on a decrease in vibration.

22. The method of claim 21, wherein decreasing the size of the objects includes decreasing the size of the objects after a second period of time.

23. The method of claim 16, wherein monitoring vibration includes monitoring motion signals of a motion sensor corresponding to a plurality of axes.
